(19) United States
(12) Patent Application Publication
(10) Pub. No.: US 2025/0316722 A1
(43) Pub. Date: Oct. 9, 2025

(54) PLATE ARRANGEMENT FOR AN ELECTROCHEMICAL CELL

(71) Applicants: SCHAEFFLER TECHNOLOGIES AG & CO. KG, Herzogenaurach (DE); BENDER GMBH MASCHINENBAU U. STRECKMETALLFABRIK, Siegen (DE)

(72) Inventors: Klaus BENDER, Siegen (DE); Hanna WINTER, Karlsruhe (DE); Jürgen REMMLINGER, Karlsruhe (DE); Thomas SWOBODA, Nürnberg (DE)

(73) Assignees: SCHAEFFLER TECHNOLOGIES AG & CO. KG, Herzogenaurach (DE); BENDER GMBH MASCHINENBAU U. STRECKMETALLFABRIK, Siegen (DE)

(21) Appl. No.: 18/865,247

(22) PCT Filed: May 12, 2023
(86) PCT No.: PCT/EP2023/062770

§ 371 Date: Nov. 12, 2024

(30) Foreign Application Priority Data
May 16, 2022 (DE) 10 2022 112 175.5

(51) Int. Cl. H01M 8/0254; H01M 8/0206; H01M 8/241

(52) U.S. Cl. CPC H01M 8/0254; H01M 8/0206; H01M 8/241

(57) ABSTRACT

A plate arrangement for an electrochemical cell, in particular a fuel cell, includes a lattice for a sandwich-like arrangement between a first plate lying in a base plane and a second plate parallel thereto, and is designed as an expanded metal. The plate arrangement a plurality of nodes and webs that connect the nodes, Rows of nodes are formed which run parallel to one another in a plan view of the lattice and define a longitudinal direction. All nodes have a planar, bent shape with a bending line that is oriented transversely to the longitudinal direction and separates two node sections from one another. At least in a subset of the nodes, one of the node sections is arranged at least approximately parallel to the plates.

### CROSS-REFERENCE TO RELATED APPLICATIONS

This application is a National Stage Application of PCT/EP2023/062770, filed May 12, 2023, which claims benefit of priority to German Patent Application No. 10 2022 112 175.5 filed on May 16, 2022, and which applications are incorporated herein by reference. To the extent appropriate, a claim of priority is made to each of the above disclosed applications.

### TECHNICAL FIELD

The invention relates to a plate arrangement, which comprises a lattice formed as an expanded metal, provided for use in an electrochemical cell, in particular a fuel cell.

### PRIOR ART

A plate arrangement of an electrochemical cell of this type is known, for example, from DE 11 2009 004 658 B4. The known plate arrangement is provided for use in a fuel cell and comprises a so-called gas channel forming element which is present in the form of an expanded metal lattice, wherein connecting sections, which is to say, nodes, of the expanded metal comprise sections which can be distinguished from one another and which are inclined in different ways relative to plates, including in the form of a separator, between which the expanded metal is inserted. In so doing, angles, in particular acute angles, can be enclosed between the node sections and the plates. An angle that is enclosed between a section of the node and the separator is smaller than an angle enclosed between another section of the node and a gas diffusion layer. DE 11 2009 004 658 B4 provides for the production of the expanded metal from titanium.

The subject matter of DE 11 2007 000 017 T5 relates to a method for forming a gas diffusion layer for a fuel cell. As part of this method, a metal lattice processing device is used, with which a stainless steel sheet is processed. The stainless steel sheet can be fed to a holding mechanism with the aid of feed rollers. With the aid of a cutting tool, which is also attributed to the metal lattice processing device, through-holes are configured in a lattice-like, staggered arrangement. The through-holes have a hexagonal shape and provide free cross-sections when the lattice is installed in a fuel cell.

A separator for a fuel cell described in U.S. Pat. No. 8,206,865 B2 is contacted by a collector formed from a metal lattice. The possibility of stacking a plurality of metal lattices to form the collector is also mentioned. A contact surface between the collector and an electrode layer should be greater than or equal to a contact surface between the collector and the separator body. Another element which forms a gas flow path in a fuel cell battery is disclosed in U.S. Pat. No. 9,160,026 B2. In this case too, the element forming the gas flow path is in the form of a metal lattice structure. The said element comprises a plurality of ring-shaped sections which form continuous openings.

U.S. Pat. No. 9,450,253 B2 describes possible geometric details of a cell structure of a fuel cell formed from expanded metal. In this case, too, the meshes of the expanded metal describe hexagonal or other polygonal shapes.

### BACKGROUND

The invention is based on the task of further developing elements for electrochemical cells, in particular fuel cells, compared to the aforementioned state of the art, in particular in terms of fluid technology as well as manufacturing technology aspects, wherein a rugged construction of the end product is sought, including suitable for mobile applications, which is to say construction of the fuel cell system or other electrochemical system, in particular in the form of a fuel cell stack.

### SUMMARY

The plate arrangement comprises, in a basic concept known per se, a lattice configured as an expanded metal which is provided for sandwich-like arrangement between a first plate lying in a base plane and a second plate parallel thereto, which lattice comprises a plurality of nodes as well as webs that connect the nodes, wherein, in a plan view of the lattice, rows of nodes are formed which extend parallel to one another and define a longitudinal direction, wherein all nodes have a planar, bent shape with a bending line that is oriented transversely to the longitudinal direction and separates two node sections of the respective node from one another.

In the present case, the arrangement is said to be approximately parallel if the node section in question encloses an angle of not more than 15° with the adjacent plate of the electrochemical system. In particular, the node section in question lies flat on the said plate, which can be formed by a membrane electrode arrangement.

With this form of plug-in metal, several functions of the plate arrangement are fulfilled equally. On the one hand, the numerous node sections of the expanded metal, which are at least approximately parallel to the plates, provide generously dimensioned contact surfaces overall, which contact surfaces absorb forces within the plate stack with moderate surface pressures as well as conduct electrical currents. On the other hand, the plate sections that are inclined together with the webs of the lattice, which is to say, the expanded metal, ensure targeted flow-conducting effects, wherein media flowing between the plates also experience flow components that are perpendicular to the plates.

Each node section, which is arranged parallel to the plates or is arranged only slightly inclined to the plates, which is to say, at an angle of less than 15°, as long as it is arranged at the edge of the lattice, is connected by means of two webs to node sections which are, to a greater extent, inclined to the plates, one of which defines the base plane, which is to say, encloses a larger angle with the plates. This means that the webs themselves are twisted. This contributes to both the conduction of flow and the mechanical stability of the expanded metal.

According to a possible configuration, in some nodes of the expanded metal, in particular in the case of nodes arranged in certain rows, the first node section is planar to the base plane, which may be given by the membrane electrode arrangement, whereas in other nodes, which are typically likewise arranged in rows, there is a distance between the nodes and the said plane, wherein the first node sections are arranged in a plane parallel to the base plane. In this configuration, in comparison to embodiments in which the first node section of a respective node contacts the base plane, there is a smaller total contact surface between the nodes and one of the plates applied to the expanded metal, but there are larger free cross-sections for the medium flowing through the plate arrangement precisely because the node sections are lifted off the base plane.

The nodes resting on the base plane and the nodes lifted off the base plane can be arranged alternatingly in a row of nodes extending in the longitudinal direction of the expanded metal. Variants of the expanded metal can likewise be realized, for example, in which two rows arranged next to each other always lie on nodes of the base plane and every third row of nodes is lifted off the base plane.

When manufacturing the expanded metal from a sheet that initially has no openings, it is possible to work with the sheet being fed at a variable rate, which is reflected in the finished product, which is to say, the expanded metal, by the presence of node sections of different lengths. The length is measured in the feed direction. The feed direction encloses a right angle with the bending line, which represents the boundary between the two node sections. The length of each node section is measured on the surface of the respective node section, which is to say, not on a projection of the node onto the base plane.

With the help of the variable feed rate that the sheet metal to be processed into expanded metal undergoes, four different types of nodes can be produced within one and the same expanded metal lattice in a single manufacturing method: in a first row of nodes, there are nodes that are formed from two long node sections, wherein one of the two node sections can be planar to the base plane. A node, which is formed from two comparatively short node sections, and which is referred to as a small node, is respectively arranged between two of these so-called large nodes, wherein in this case both node sections are arranged inclined to the base plane. There are different variants of medium-sized nodes in a second row of nodes, which is completely lifted off the base plane. Here, one of the node sections is respectively spaced apart from the base plane as well as from the second plate, by way of example in parallel, whereas the second node section, which is the only section that is inclined or, inclined in a more pronounced form, makes linear contact with the second plate.

The first variant of the nodes is made up of a short node section, which is, in particular, parallel to the plates and a second, comparatively long node section. Reversed conditions are present in the second variant: in this case, a long node section parallel to the plates is connected to a comparatively shorter node section that is at a greater inclination extending to the second plate. The webs which connect the nodes with each other extend either from a long node section to another long node section or between two short node sections, so that each web has a uniform width.

Expanded metal lattice with more than two different rows of nodes, for example, with three or four different rows of nodes, can also be realized making use of other feed length variants during production. It is also conceivable that different types of rows of nodes are respectively each made up exclusively of nodes the adjacent sections of which, in each individual case, have different lengths.

The node sections are generally also referred to as half node points. If a node section is arranged parallel to the base plane, irrespective of the actual orientation of the plate arrangement in space, for the sake of simplicity, it is also referred to as a horizontal node section. In various forms of the expanded metal, between the two node sections of a node, for example, an angle of at least 90° and a maximum of 150° can be enclosed.

The plate, which is generally referred to as the second plate, is in particular a bipolar plate. The bipolar plate can be constructed in a known manner from two half-metal sheets, between which channels for a coolant are formed. A configuration of the second plate as a monopolar plate is also possible. Both in the case of a bipolar plate and in the case of a monopolar plate, the term separator is also used for the second plate.

The first plate-shaped arrangement defining the ground plane, which is referred to as the first plate for short, comprises, in particular, a proton-permeable polymer electrolyte membrane (PEM). In a typical configuration, porous anode and cathode catalyst layers as well as porous gas diffusion layers, which are also attributable to the first plate, are adjacent to the PEM. Thus, within a plate stack comprising a plurality of similar plate arrangements, there is contact between the various gas diffusion layers and the expanded metal lattices. In every case, flow fields for the operating media of the electrochemical system are always formed by the expanded metal lattice, irrespective of the geometric design of the expanded metal.

In the already described configuration, in which an expanded metal produced with variable feed rate is used, the row of nodes that is lifted off the base plane can, for example, be at a distance from the base plane that corresponds to at least 30% and at most 60% of the distance between the two plates, which is to say, the thickness of the expanded metal lattice.

According to a further possible embodiment, the nodes of one row of nodes of the first type exclusively contact the first plate of the plate arrangement, whereas the nodes of one row of nodes of the second type exclusively contact the second plate. In this case, the node sections of all nodes can comprise a uniform length, wherein-when viewed in the transverse direction of the expanded metal-the rows of nodes of the first and second type are arranged alternatingly. Assuming a horizontal arrangement of the plate arrangement, the nodes of the different rows of nodes are found at different heights, which can be seen as a wavy shape of the expanded metal in its transverse direction. The wavy shape keeps particularly large flow cross-sections free within the plate arrangement. In this case, all webs have a uniform width, which is determined by the feed rate during the manufacturing method.

In a further developed embodiment, a variable feed rate, which is expressed in node sections of non-uniform width, is combined with a corrugation of the expanded metal. In this case too, as in the configuration already elucidated in detail, there are different rows of nodes, wherein in one row of nodes, long and short nodes are arranged alternatingly one after the other, whereas in the second row of nodes, medium-length nodes of different characteristics are present. In contrast to the already elucidated configuration, the further developed embodiment can distinguish itself, in particular, by the fact that the nodes of medium length are lifted particularly far off the first plate. Due to a distance of the horizontal node sections of these nodes from the first plate in the range of, for example, 50%±10%, in particular 50%±5%, of the plate spacing, particularly generously dimensioned flow channels are formed which extend in the longitudinal direction through the plate arrangement and which flow channels can extend from the inlet to the outlet of a flow field.

### BRIEF DESCRIPTION OF THE DRAWINGS

Four embodiments of the invention are elucidated in more detail below with reference to a drawing. Wherein:

FIG. 1 shows a first embodiment of an expanded metal lattice for an electrochemical cell,

FIG. 2 shows a plate arrangement of an electrochemical cell including the expanded metal lattice according to FIG. 1,

FIG. 3 through FIG. 5 show further representations of the expanded metal lattice according to FIG. 1,

FIG. 6 shows a second embodiment of an expanded metal lattice for an electrochemical cell,

FIG. 7 shows a plate arrangement of an electrochemical cell including the expanded metal lattice according to FIG. 6,

FIG. 8 through FIG. 12 show further representations of the expanded metal lattice according to FIG. 6,

FIG. 13 shows a third embodiment of an expanded metal lattice for an electrochemical cell,

FIG. 14 shows a plate arrangement of an electrochemical cell including the expanded metal lattice according to FIG. 13,

FIG. 15 through FIG. 19 show further representations of the expanded metal lattice according to FIG. 13,

FIG. 20 shows a fourth embodiment of an expanded metal lattice for an electrochemical cell,

FIG. 21 shows a plate arrangement of an electrochemical cell including the expanded metal lattice according to FIG. 20,

FIG. 22 through FIG. 26 show further representations of the expanded metal lattice according to FIG. 20.

### DETAILED DESCRIPTION OF THE EMBODIMENTS

Unless otherwise stated, the following explanations refer to all embodiment examples. Parts or contours of parts that correspond to each other or, in principle, have the same effect are marked with the same reference signs in all figures.

In the embodiment examples, an electrochemical cell marked overall with the reference sign 1 is a fuel cell which comprises a plurality of similar, stacked plate arrangements 2. As regards the basic construction and the function of the stack of electrochemical cells 1, reference is made to the state of the art cited at the beginning.

The plate arrangement 2 is attributable to an expanded metal lattice 3, which is also referred to as expanded metal or lattice for short. The plate arrangement 2, moreover, comprises a first plate-shaped arrangement 5, namely a membrane electrode arrangement including gas diffusion layers, which is also referred to as the first plate for the sake of simplicity. The plate arrangement 2 is, moreover, attributable to a second plate 4, which is part of a bipolar plate.

The surface of plate 5, which contacts the expanded metal 3, defines a base plane of the plate arrangement 2. There are significant differences between the two plates 4 and 5 in terms of mechanical load-bearing capacity. Both plates 4, 5 are intended to conduct electrical currents, wherein electrical currents flow, in particular, through contact areas between the lattice 3 and the various plates 4, 5. An important function with regard to the conduction of liquid and/or gaseous media, which is to say, operating media of the electrochemical cell 1, is also attached to the expanded metal 3.

The lattice 3 comprises a plurality of nodes 6, each of which comprises a first node section 7 and a hereto inclined node section 8, which can partially be seen in simplified form in the figures. In the embodiment examples, the first node section 7 is arranged parallel to the plates 4, 5. The node sections 7, 8 are contiguous to each other at a bending line. The angle between the node sections 7, 8 is labeled α.

The nodes 6 of the lattice 3 are connected to each other by webs 10, 11, such that openings 9 with a diamond-shaped basic form are formed. A flow channel formed by the lattice 3 between the plates 4, 5 is designated overall by 12. The medium flowing through the plate arrangement 2 flows overall in the longitudinal direction of the plate arrangement 2, designated LR. The dimension SWD (Short Way Diagonal) of the meshes of the lattice 3 is to be measured in the longitudinal direction LR. The dimension LWD (Long Way Diagonal) is likewise conventionally measured at right angles to the longitudinal direction LR. KB indicates the node width, which is to say, the matching width of the node sections 7, 8. SH indicates the expanded lattice height, which is to say, the distance between the plates 4, 5. The substantially uniform wall thickness of the lattice 3 to be measured at the horizontal sections 7 is indicated by WS. The nodes 6 are arranged in rows of nodes KR1, KR2, which run in the longitudinal direction LR.

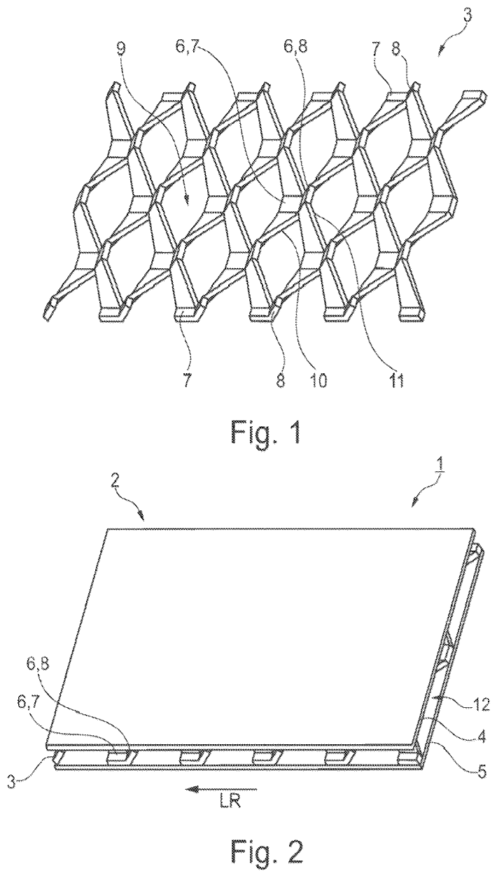

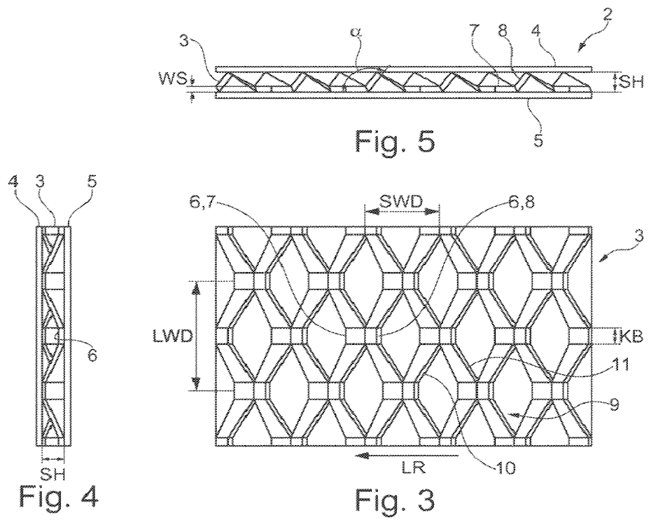

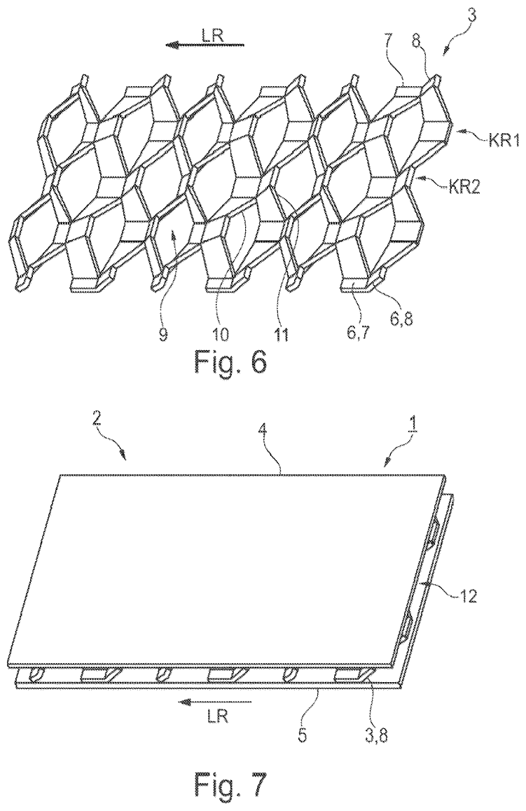

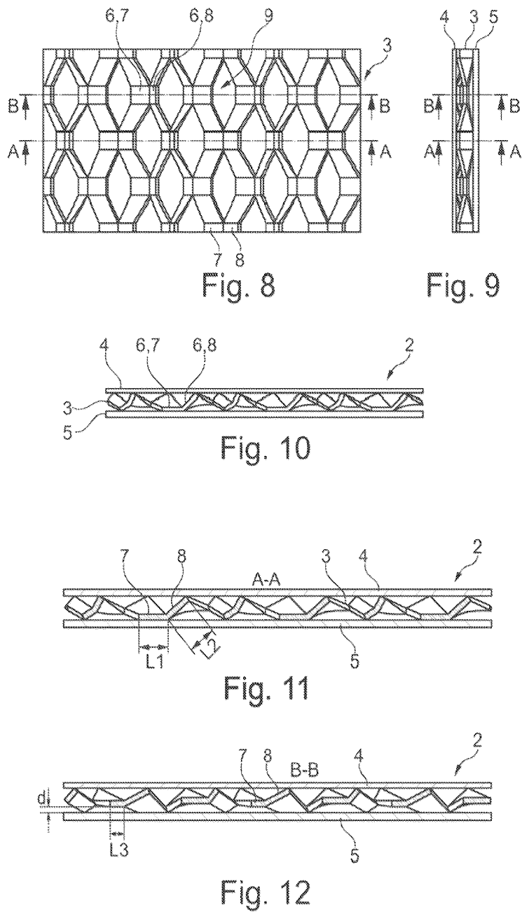

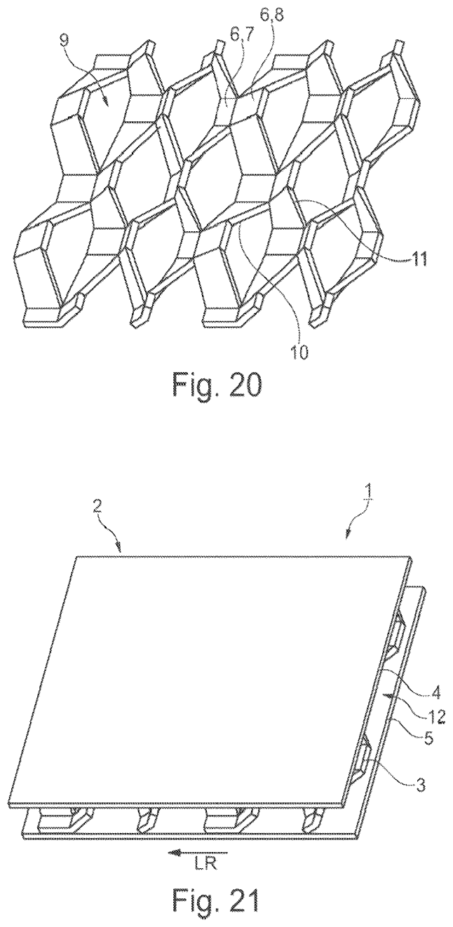

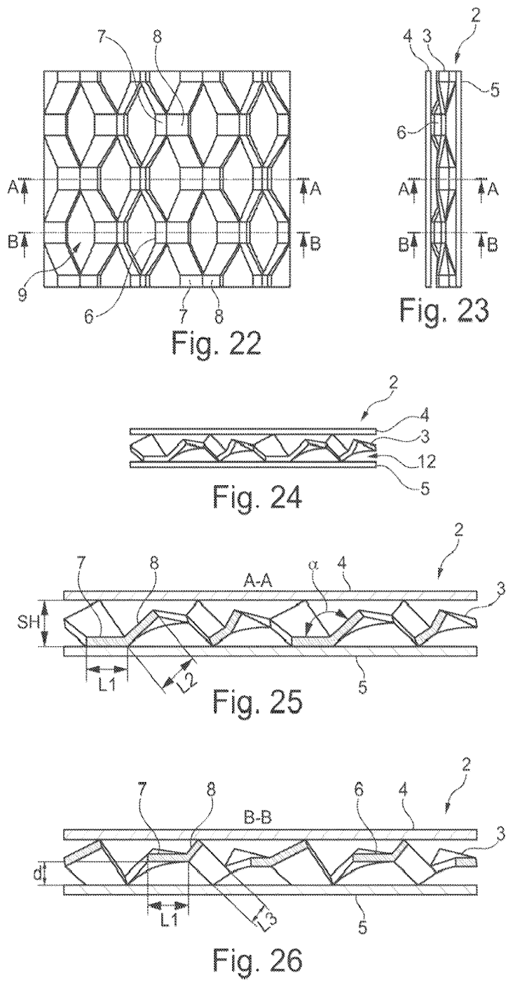

In the embodiment example according to FIG. 1 through FIG. 5, unlike in the embodiment examples according to FIG. 6 through FIG. 14 and according to FIG. 20 through FIG. 26, all rows of nodes KR1, KR2 are similarly designed. In so doing, all node sections 7 lie planar on the first plate 5, which is to say, the membrane electrode arrangement. In contrast, the second plate 4, which is flat in the areas shown in the embodiment examples, is only contacted by edges of the second node section 8, but this is tolerable due to the given current carrying capacity and mechanical load capacity of the second plate 4. In the direction of flow, which is to say, in the longitudinal direction LR, each node 6 of the expanded metal 3 according to FIG. 1 represents a barrier filling the space between the plates 4, 5, wherein the inclined position of the sections 8 contributes to the medium being directed past the node 6 in the direction of the neighboring webs 10, 11. Each web 10, 11 connects a horizontal node section 7 with an inclined node section 8, which means that the web 10, 11 itself is twisted. Such a twisting of the webs 10, 11 also exists in all other embodiment examples and contributes to the flowing medium experiencing a component of movement in the normal direction to the plates 4, 5. The twisting of the webs 10, 11, together with the bent shape of the nodes 6, moreover, increases the stability of the overall expanded metal 3.

The embodiment according to FIG. 6 through FIG. 12 differs significantly from the embodiment according to FIG. 1 through FIG. 5 in that the adjacent sections 7, 8 of the nodes 6 are of different lengths. This is achieved by a variable feed rate of the sheet metal from which the expanded metal 3 is manufactured.

As can be seen in particular from FIG. 12, in the case of the expanded metal lattice 3 according to FIG. 6, all nodes 6 of the first row of nodes KR1 are lifted off the membrane electrode arrangement 5. In contrast, as can be seen in FIG. 11, the nodes 6 of the second row of nodes KR2 are in contact with the membrane electrode arrangement 5 either in a planar or linear manner. In the latter case, the row of nodes KR2 is formed by alternatingly-arranged longer and shorter nodes 6. In so doing, the length of the first node section 7 of a longer node 6 is labeled L1. The inclined node section 8 subsequent to the longer node section 7 has a length L2, which in the case shown corresponds to the length L1. The node 6 that is next in the row of nodes KR2 is a short node, wherein in this case both node sections 7, 8 are positioned inclined to plates 4, 5. Each of the node sections 7, 8 has a length L3 that is lesser than the length L1. Due to the more pronounced inclined position of the short nodes 6 compared to the longer nodes 6, the shorter nodes 6 also extend from the surface of the bipolar plate 4 to the surface of the first plate 5. In this way, all nodes 6 of the row of nodes KR2 of the lattice 3 according to FIG. 6 extend over the entire expanded lattice height SH.

In contrast to the nodes 6 of the row of nodes KR2, all nodes 6 of the first row of nodes KR1 contact the second plate 4, but not the first plate 5. In the case of the first row of nodes KR1, a combination of a short and a long node section 7, 8 is given for each node 6. If the first node section 7 is a short node section with a length L3, then the second, short inclined node section 8 is a long node section with a length L2. On the other hand, the next nodes 6 in the row of nodes KR1 have the reverse length ratios. The first, horizontal node section 7 is configured as a long node section of length L1. The subsequent, inclined node section 8 is a short section of the length L3. In the embodiment example according to FIG. 6 through FIG. 12, the distance d is less than half the expanded lattice height SH. Depending on the relationship between the distance d and the expanded lattice height SH, as well as the flexibility of the first plate 5, the first plate 5 may also have a disposition against the nodes 6 of the first row of nodes KR1. Otherwise, as can be seen from FIG. 12, a free space is formed between the nodes 6 of the first row of nodes KR1 and the plate 5, which is attributable to the flow channel 12.

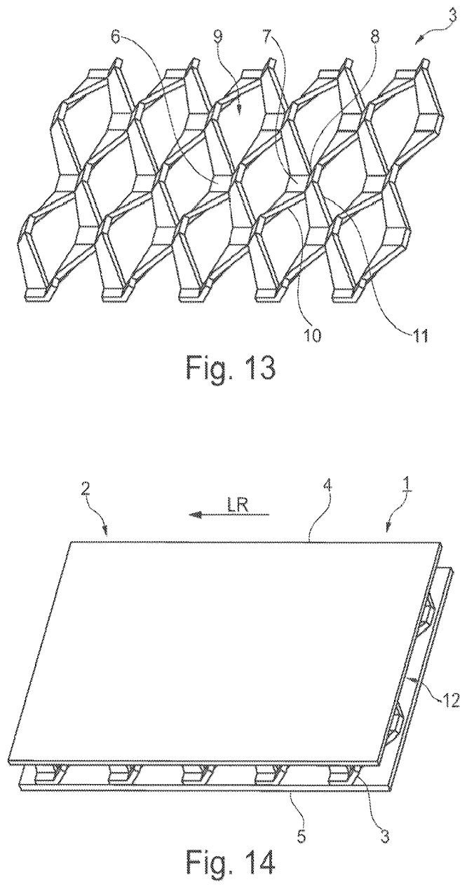

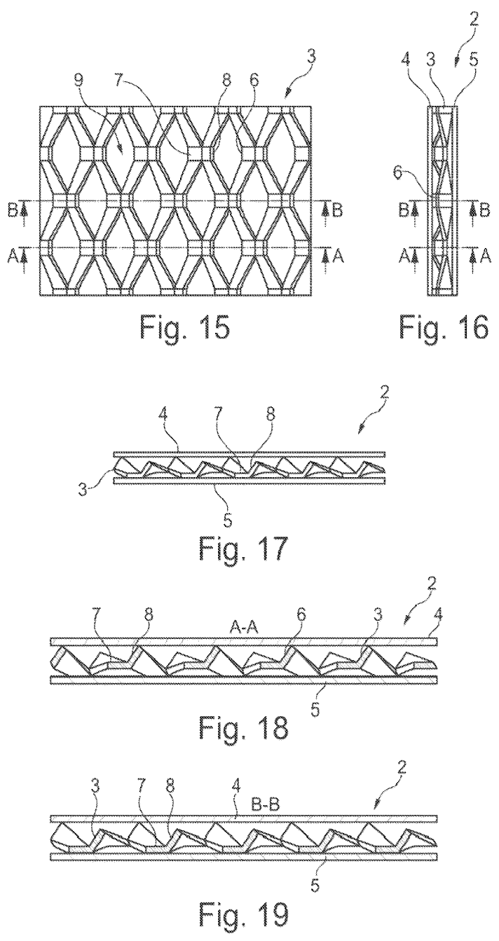

As can be seen in FIG. 18, the nodes 6 of the row of nodes KR1 are also lifted off the first plate 5 in the embodiment example according to FIG. 13 through FIG. 19. As can also be seen from FIG. 18, these nodes 6 are in contact at the same time with the bipolar plate 4. The opposite applies to the nodes 6 of the second row of nodes KR2. In this case, all node sections 7 rest on the first plate 5, whereas the inclined node sections 8 are spaced at a distance from the bipolar plate 4. In cross-section, all nodes 6 of the row of nodes KR1, KR2 have a uniform cross-sectional shape, as can be seen from a comparison of FIG. 18 and FIG. 19. The length of the node sections 7, 8 is in all cases L1. Overall, in the embodiment according to FIG. 13 through FIG. 19 there is a corrugated expanded metal 3.

In the embodiment according to FIG. 24 through FIG. 26, features of the embodiment according to FIG. 13 through FIG. 19 are combined with features of the embodiment according to FIG. 6 through FIG. 12. Accordingly, in the case of FIG. 20 through FIG. 26, there is a corrugated expanded metal 3 produced with variable feed rate. FIG. 25 shows the cross-sectional shape of the nodes 6 in the second row of nodes KR2. There is a similarity with the configuration according to FIG. 11 if, in the longitudinal direction LR, alternating nodes 6, which are formed from two long node sections 7, 8, and nodes 6, which are formed from two short node sections 7, 8, each having the length L3, are in a row while maintaining distances, which are present as openings 9. In contrast to the configuration according to FIG. 11, in the case of FIG. 25, all nodes 6 of the row of nodes KR2 are, however, spaced at a distance from the bipolar plate 4. As far as the first row of nodes KR1 is concerned, the cross-sectional design that results from FIG. 26 is basically comparable to the cross-sectional design according to FIG. 12. This means that all inclined node sections 8 are in contact with the bipolar plate 4, whereas the horizontal node sections 7 are lifted off the first plate 5. In the case of FIG. 27, the distance d between the horizontal node sections 7 and the first plate 5 corresponds to approximately half of the expanded lattice height SH. In this case, the longer node sections 7, each having a length of L1, are spaced at a slightly greater distance from the first plate-shaped arrangement 5 than are the shorter node sections 7, each having a length of L3. Overall, in the case of the embodiment according to FIG. 20 to FIG. 26, there is a particularly wider, more open cross-section of the flow channel 12, wherein at the same time there are planar, material-protecting dispositions of the expanded metal 3 with the first plate-shaped arrangement 5.

### LIST OF REFERENCE SYMBOLS

1. Electrochemical cell, fuel cell
2. Plate arrangement
3. Expanded metal, lattice
4. Second plate, bipolar plate
5. First plate-shaped arrangement, membrane electrode arrangement
6. Nodes
7. First node section
8. Second node section, inclined
9. Opening
10. Web
11. Web
12. Flow channel
α Angle
d Distance
KB Node width
KR1, KR2 Rows of nodes
L1 Length
L2 Length
L3 Length
LR Longitudinal direction
LWD Width in transverse direction
SH Expanded lattice height
SWD Width in longitudinal direction
WS Wall thickness

1. A plate arrangement for an electrochemical cell, comprising a lattice configured as an expanded metal for a sandwich-like arrangement between a first plate lying in a base plane and a second plate parallel to the first plate, said lattice comprises a plurality of nodes, and webs that connect the nodes, wherein, in a plan view of the lattice, rows of nodes are formed which extend parallel to one another and define a longitudinal direction, wherein all nodes have a planar, bent shape with a bending line that is oriented transversely to the longitudinal direction and separates two node sections from one another, wherein, at least in a subset of the nodes, one of the node sections is respectively arranged at least substantially parallel to the said plates.

2. The plate arrangement according to claim 1, wherein at least in some of the nodes of said subset, the first node section encloses an angle of less than 15 degrees with the base plane.

3. The plate arrangement according to claim 2, comprising additional nodes (6) exist which are also in said subset, and respectively comprise a node section spaced apart from the base plane.

4. The plate arrangement according to claim 1, comprising nodes having node sections which have a matching length.

5. The plate arrangement according to claim 1, wherein a length of the first node section differs at least for some nodes from a length of the second node section.

6. The plate arrangement according to claim 4, wherein in one of the rows of nodes, exclusively nodes with two node sections of equal length are arranged, wherein nodes with two long node sections alternate with nodes which are formed from two short node sections, and, in another row of nodes, exclusively nodes with node sections of unequal length are arranged, wherein, in the row of nodes with node sections of unequal length, one node with a long section which is at least substantially parallel to the plates and a short, more inclined section and one node with a short section which is at least substantially parallel to the plates and a long, comparatively strongly inclined section are arranged alternatingly one behind the other in rows.

7. The plate arrangement according to claim 6, wherein, the row of nodes, which is formed from nodes with node sections of equal length, is tangent to the base plane with the node sections which are at least approximately parallel to the plates, wherein the other row of nodes with the node sections which are at least approximately parallel to the base plane is spaced from the base plane by a distance which not less than 30% and at most 60% of a distance between the two plates, which is to say, the a thickness of the lattice.

8. The plate arrangement according to claim 1, wherein, an angle of at least 90° and at most 150° is enclosed between the two node sections of a node.

9. A fuel cell comprising of a plate arrangement according to claim 1.

10. A stack of electrochemical cells, comprising a plurality of the plate arrangements according to claim 1, wherein the first and second plates contact the lattice, namely including a membrane electrode arrangement as the first plate and a bipolar plate as the second plate.

11. The plate arrangement according to claim 1, wherein, at least in some of the nodes of said subset, the first node lies planar on the base plane.
